(19) United States
(12) Patent Application Publication
(10) Pub. No.: US 2019/0336397 A1
(43) Pub. Date: Nov. 7, 2019

(54) Dosage Cup and Measurement Kit

(71) Applicant: Lone Star Pharmacy Products, L.L.C., Flower Mound, TX (US)

(72) Inventor: Kenneth D. Ferrara, Rusk, TX (US)

(21) Appl. No.: 16/282,624

(22) Filed: Feb. 22, 2019

Related U.S. Application Data
(60) Provisional application No. 62/665,912, filed on May 2, 2018.
(60) Provisional application No. 62/671,258, filed on May 14, 2018.

(51) Int. Cl. A61J 7/00; G01F 19/00

(52) U.S. Cl. CPC A61J 7/0046; G01F 19/002; A61J 2200/76; A61J 7/0053; A61J 2205/20; A61J 7/0023

(57) ABSTRACT

A measurement kit may provide items including at least one dosage cup or container, at least one measurement spoon, at least one dosing spoon, at least one syringe, at least one magnifying glass or lens, and measurement instructions. Each of the items provided in the measurement kit may provide measurement indicators that may indicate volumetric measurements and be sized to fit into existing medicine containers or boxes. A dosage cup or container may provide an interior shape that may prevent liquid from remaining at a bottom of the cup or container when the contents of the dosage cup or container are emptied. The dosage cup or container may provide a plurality of measurement indicators about an exterior of the dosage cup or container that are colored or color-coded to correspond to volumetric measurements, and the measurement instructions are color-coded and include color-matched labels.

### CROSS-REFERENCE TO RELATED APPLICATIONS

The present application claims the benefit under 35 U.S.C. 119(e) of U.S. Provisional Application Ser. No. 62/671,258 filed on May 14, 2018 entitled “Dosage Cup and Measurement Kit” and U.S. Provisional Application Ser. No. 62/665,912 filed on May 2, 2018 entitled “Dosage Cup and Measurement Kit,” the disclosures of which are incorporated by reference in their entirety.

### TECHNICAL FIELD

The disclosure relates generally to measurement containers. In particular, the disclosure relates to a measurement kit including at least one dosage cup having an interior shape to prevent liquid from remaining at the bottom of the at least one dosage cup.

### BACKGROUND

Dosage cups typically provide a shape can allow liquid or the contents to settle at the bottom of the cup and remain in the cup even after being emptied by a user. Thus, some users can consume less dosage than intended or struggle to remove all of the contents from the dosage cup. Measurement kits that provide a plurality of measurement containers in different shapes and forms typically provide dosage cups in which liquid or the contents of the cup settles at the bottom of the cup.

### SUMMARY

Embodiments of the present disclosure may provide at least one dosage cup that may include a plurality of measurement indicators that may be provided about an exterior of the at least one dosage cup. An interior bottom of the at least one dosage cup may be shaped to prevent contents of the at least one dosage cup from remaining inside of the at least one dosage cup. The plurality of measurement indicators may be color-coded and/or colored using primary colors including, but not limited to, orange, purple, green, yellow, red, and blue.

Other embodiments of the present disclosure may provide a container that may include a plurality of measurement indicators that may be provided about an exterior of the container. The container may include an interior bottom that may be shaped to prevent contents placed into the container from remaining inside of the container after a user has attempted to consume the contents. The plurality of measurement indicators may be color-coded and/or may be colored using primary colors including, but not limited to, orange, purple, green, yellow, red, and blue.

A measurement kit may include at least one container that may have an interior bottom that may be shaped to prevent contents placed into the at least one container from remaining inside of the at least one container after a user has attempted to consume the contents. The measurement kit may include at least one spoon that may have a spoon measurement indicator provided on a handle of the spoon. The at least one spoon may be solid colored in embodiments of the present disclosure. The measurement kit may provide at least one syringe that may have a plurality of syringe measurement indicators provided about an exterior of the at least one syringe. The measurement kit may provide a plurality of container measurement indicators that may be provided about an exterior of the at least one container. The measurement kit may include a magnifying glass or lens that may be provided to enlarge the spoon measurement indicator, the plurality of syringe measurement indicators, the plurality of container measurement indicators, and any text or symbols provided on the at least one container, the at least one spoon, and the at least one syringe. The at least one spoon may include a measurement spoon, a dosing spoon, or combinations of the same.

Other technical features may be readily apparent to one skilled in the art from the following drawings, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is a view of dosage cups or containers according to an embodiment of the present disclosure;

FIG. 2 is a view of measurement spoons according to an embodiment of the present disclosure;

FIG. 3 is a view of a syringes according to an embodiment of the present disclosure;

FIG. 4 is a front view of a measurement kit according to an embodiment of the present disclosure;

FIG. 5 is a rear view of measurement kit according to an embodiment of the present disclosure; and

FIG. 6 is a measurement kit according to another embodiment of the present disclosure.

### DETAILED DESCRIPTION

The present disclosure generally provides at least one dosage cup or container 100. Measurement kit 400, 500 may include at least one dosage cup or container 100, at least one measurement spoon 200, which may be a solid colored spoon, at least one syringe 300, at least one magnifying glass or lens 410, and measurement instructions 420. However, it should be appreciated that the measurement kit may include less than all of these components or additional components without departing from the present disclosure.

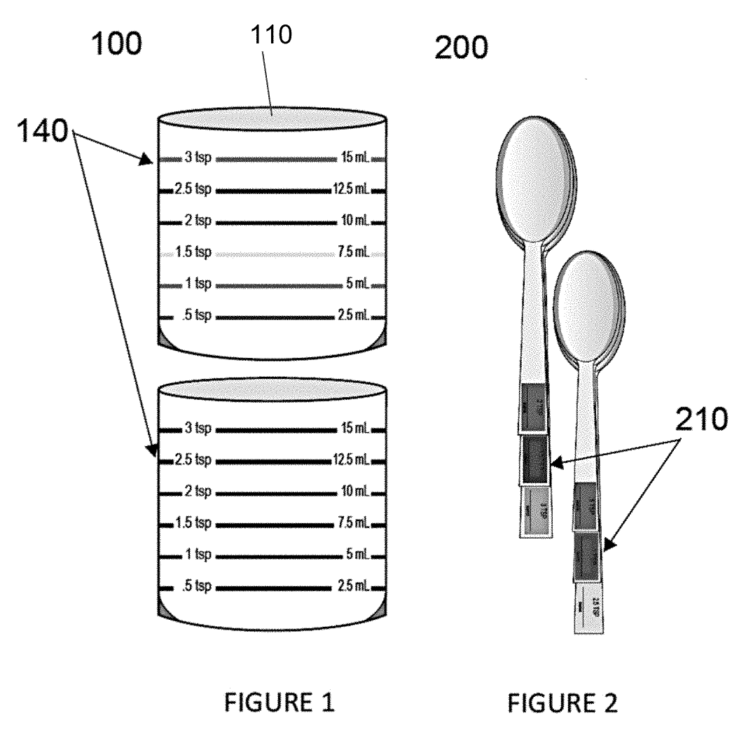

FIG. 1 depicts dosage cup or container 100 that may provide interior 110 that may be shaped to prevent contents from remaining in bottom 120 of dosage cup 100 when a user desires to completely empty interior 110, such as through consumption of the contents. The shape of interior 110 may provide fillet(s) or rounding of interior corners 130 to angle contents toward an opening of dosage cup or container 100 when turned upside down to empty contents. It should be appreciated that interior 110 of dosage cup or container 100 may not be completely emptied if the user desires to maintain some of the contents in dosage cup or container 100.

It should further be appreciated that dosage cup or container 100 may be shaped and/or designed to remove or empty more contents than other traditional containers. It should be appreciated that the contents may include, but is not limited to, liquids and solids. It should further be appreciated that liquids provided in dosage cup 100 may be thick and/or viscous fluids in some embodiments of the present disclosure. A plurality of measurement indicators 140 may be color-coded or colored using primary colors including, but not limited to, orange, purple, green, yellow, red, and blue.

FIG. 2 depicts measurement spoons 200 that may provide measurement spoon indicators 210. Measurement spoon indicators 210 may be provided on handles 220 of measurement spoons 200. It should be appreciated that each of measurement spoons 200 may provide measurement spoon indicators 210 that may include, but are not limited to, 3 teaspoons, 2.5 teaspoons, 2 teaspoons, 1.5 teaspoons, 1 teaspoon, and 0.5 teaspoons. It should be appreciated that measurement spoon indicators 210 may use indications other than teaspoons without departing from the present disclosure. In an embodiment of the present disclosure, milliliters may be used instead of teaspoons. It should further be appreciated that measurement spoon indicators 210 may be color-coded or colored. Plurality of measurement indicators 210 may be color-coded or colored using primary colors including, but not limited to, orange, purple, green, yellow, red, and blue.

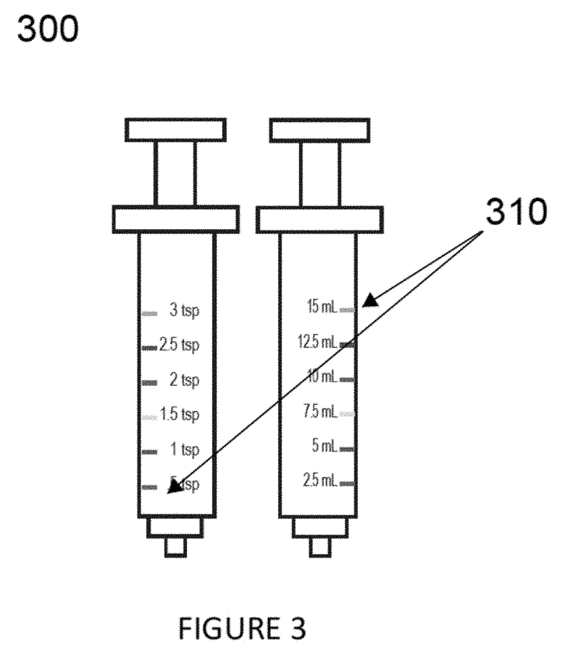

FIG. 3 depicts syringes 300 that may provide syringe measurement indicators 310. Syringe measurement indicators 310 may provide measurements including, but are not limited to, 3 teaspoons, 1.5 teaspoons, 2 teaspoons, 2.5 teaspoons, 1 teaspoon, and 0.5 teaspoons. It should be appreciated that syringe measurement indicators 310 may use indications other than teaspoons, such as milliliters, without departing from the present disclosure. It should further be appreciated that syringe measurement indicators 310 may be color-coded or colored in some embodiments of the present disclosure.

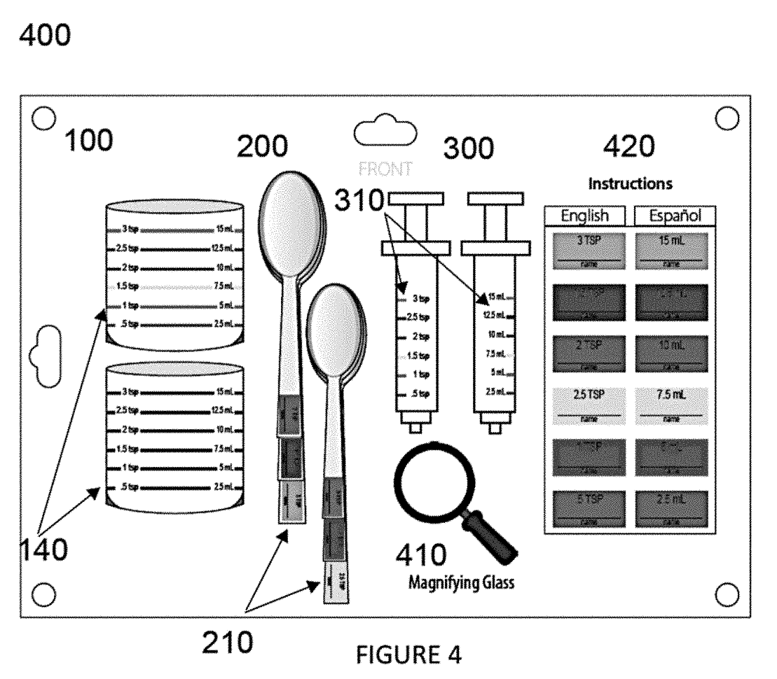

FIG. 4 depicts a front view of measurement kit 400 including, but not limited to, at least one dosage cup or container 100, at least one measurement spoon 200, at least one syringe 300, at least one magnifying glass or lens 410, and measurement instructions 420. A plurality of measurement indicators 140, 210, and 310 may be color-coded or colored using primary colors including, but not limited to, orange, purple, green, yellow, red, and blue. A plurality of measurement indicators 140, 210, and 310 may provide measurements including, but are not limited to, 3 teaspoons, 2.5 teaspoons, 2 teaspoons, 1.5 teaspoons, 1 teaspoon, and 0.5 teaspoons. It should be appreciated that measurement indicators 140, 210, 310 may use indications other than teaspoons, such as milliliters, without departing from the present disclosure. It should further be appreciated that the plurality of measurement indicators 140, 210, and 310 may be color-coded or colored in embodiments of the present disclosure. Measurement instructions 420 may be provided in English, Spanish, and/or other languages. Measurements may be provided in teaspoons, tablespoons, liters, milliliters, and other volumetric measurements. It should be appreciated that measurement instructions 420 may be provided as one or more labels that may be color-coded to correspond to the volumetric measurement provided on each label. It also should be appreciated that the one or more labels may include a line or place for a name to be written. Accordingly, it may be clearer which volumetric measurement is meant for a specific individual whose name is written on the label.

It should be appreciated that all products may be included in a single packaging in an embodiment of the present disclosure. For example, at least one dosage cup or container 100, at least one measurement spoon 200, at least one dosing spoon, at least one syringe 300, at least one magnifying glass or lens 410, and measurement instructions 420 may fit into an existing Tylenol® box or another similar type of medication box. It should also be appreciated that some products may be included in a single packaging without departing from the present disclosure. For example, at least one dosage cup or container 100, at least one magnifying glass or lens 410, and measurement instructions 420 may fit into an existing Tylenol® box. It should further be appreciated that at least one magnifying glass or lens 410 may be a significantly flat, plastic device that may occupy minimal space and fit into existing medicine containers. It should also be appreciated that magnifying tape may be utilized to read measurements and may be included in a kit or existing medicine containers in addition to or in place of at least one magnifying glass or lens 410 without departing from the present disclosure. It should be appreciated that the measurement instructions may be placed on the box itself in some embodiments of the present disclosure, such as in connection with the dosage section or near the warning label.

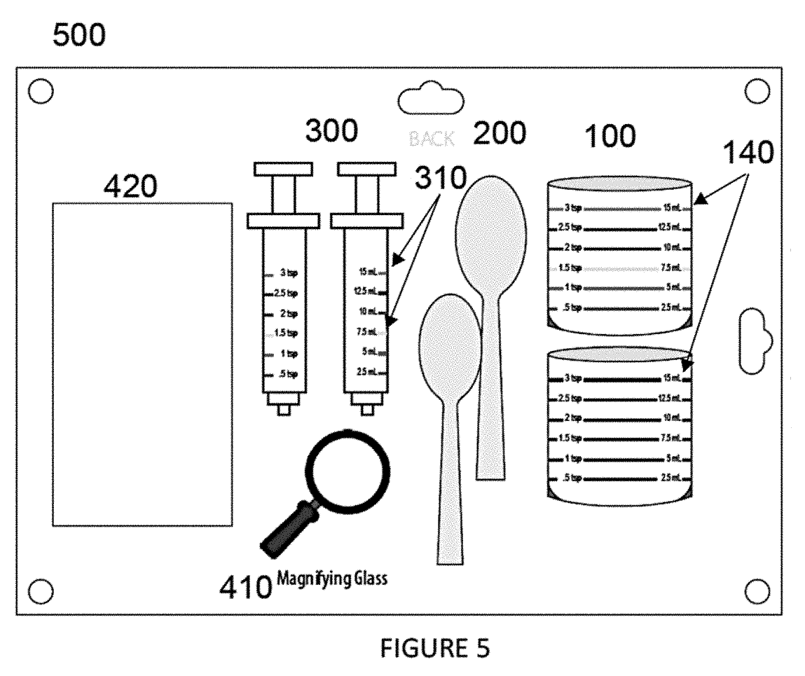

FIG. 5 depicts a rear view of measurement kit 500 including, but not limited to, at least one dosage cup or container 100, at least one measurement spoon 200, at least one syringe 300, at least one magnifying glass or lens 410, and measurement instructions 420. A plurality of measurement indicators 140, 210 (FIGS. 2 and 4), and 310 may be color-coded or colored using colors including, but not limited to, orange, purple, green, yellow, red, and blue. The plurality of measurement indicators 140, 210, and 310 may provide measurements including, but are not limited to, 3 teaspoons, 1.5 teaspoons, 2 teaspoons, 2.5 teaspoons, 1 teaspoon, and 0.5 teaspoons. It should further be appreciated that plurality of measurement indicators 140, 210 (FIGS. 2 and 4), and 310 may be color-coded or colored. Measurements may be provided in teaspoons, tablespoons, liters, milliliters, and other volumetric measurements without departing from the present disclosure.

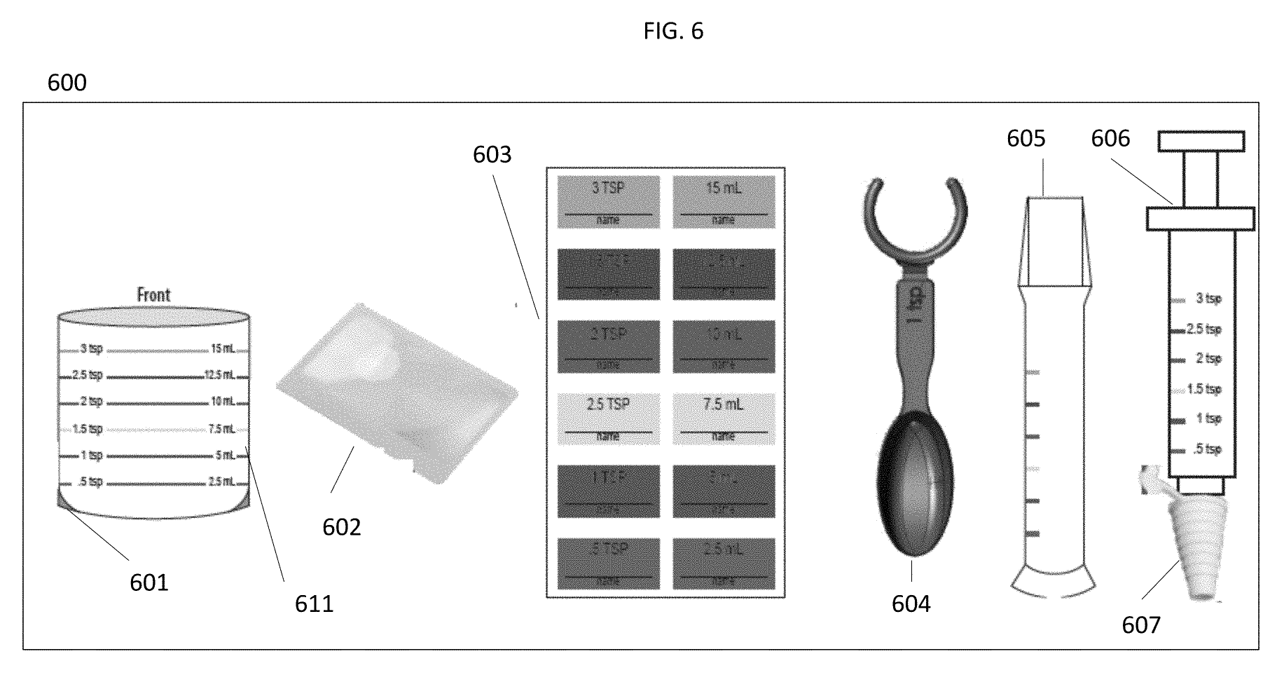

FIG. 6 depicts measurement kit 600 according to another embodiment of the present disclosure. Measurement kit 600 may include at least one dosage cup or container 601, magnifying glass or lens 602, measurement instructions 603, at least one measurement spoon 604, at least one dosing spoon 605, and at least one syringe 606.

At least one dosage cup or container 601 may include a plurality of measurement indicators 611, which may be color-coded or colored using colors including, but not limited to, orange, purple, green, yellow, red, and blue. The plurality of measurement indicators 611 may provide measurements including, but are not limited to, 3 teaspoons, 2.5 teaspoons, 2 teaspoons, 1.5 teaspoons, 1 teaspoon, and 0.5 teaspoons. It should further be appreciated that the plurality of measurement indicators 611 may be color-coded or colored. Measurements may be provided in teaspoons, tablespoons, liters, milliliters, and other volumetric measurements without departing from the present disclosure. It also should be appreciated that more than one type of volumetric measurement may be provided on the at least one dosage cup or container 601 without departing from the present disclosure. When in use, the at least one dosage cup or container 601 may be filled to the recommended dosage based on the color-coded or colored lines (plurality of measurement indicators 611). Magnifying glass or lens 602 may be used to read small print on liquid medicine and/or dosing and warning labels according an embodiment of the present disclosure.

Measurement instructions 603 may include one or more labels that may be applied to a medicine bottle below the prescription/medication label that typically appears on a medicine bottle or on the back of the medicine bottle in embodiments of the present disclosure. It should be appreciated that the label applied to a medicine bottle should not cover a prescription label that may already be present on the medicine bottle. The one or more labels may include a plurality of colors, volumetric measurements, and also may include a line or place to write an individual's name to be associated with the dosage/medicine bottle. As the individual's name typically will be written in pen, marker, or pencil, it should be appreciated that care should be taken not to wash the bottle and label in a manner that erases or blurs the individual's name.

At least one measurement spoon 604 may be included in measurement kit 600. At least one measurement spoon 604 may be colored or color-coded to correspond to a volumetric measurement in embodiments of the present disclosure. As depicted in FIG. 6, at least one measurement spoon also may include a semicircular component that may be integral to the spoon so that it may be attached to a medicine bottle in embodiments of the present disclosure. It also should be appreciated that there may be embodiments of the present disclosure where at least one measurement spoon also may include the volumetric measurement printed on it.

At least one dosing spoon 605 (which also be referred to as a shovel spoon) may be included in measurement kit 600 in an embodiment of the present disclosure. As discussed with respect to at least one dosage cup or container 601, at least one dosing spoon 605 may include a plurality of measurement indicators 611, which may be color-coded or colored using colors including, but not limited to, orange, purple, green, yellow, red, and blue. The plurality of measurement indicators 611 may provide measurements including, but are not limited to, 3 teaspoons, 2.5 teaspoons, 2 teaspoons, 1.5 teaspoons, 1 teaspoon, and 0.5 teaspoons. It should further be appreciated that the plurality of measurement indicators 611 may be color-coded or colored. Measurements may be provided in teaspoons, tablespoons, liters, milliliters, and other volumetric measurements without departing from the present disclosure. It also should be appreciated that more than one type of volumetric measurement may be provided on the at least one dosing spoon 605 without departing from the present disclosure. In use, at least one dosing spoon 605 may be filled to a recommended dosage using color-coded or colored lines provided on the at least one dosing spoon 605.

Measurement kit 600 also may include at least one syringe 606 in an embodiment of the present disclosure. As discussed with respect to at least one dosage cup or container 601 and at least one dosing spoon 605, at least one syringe 606 may include a plurality of measurement indicators 611, which may be color-coded or colored using colors including, but not limited to, orange, purple, green, yellow, red, and blue. The plurality of measurement indicators 611 may provide measurements including, but are not limited to, 3 teaspoons, 2.5 teaspoons, 2 teaspoons, 1.5 teaspoons, 1 teaspoon, and 0.5 teaspoons. It should further be appreciated that the plurality of measurement indicators 611 may be color-coded or colored. Measurements may be provided in teaspoons, tablespoons, liters, milliliters, and other volumetric measurements without departing from the present disclosure. It also should be appreciated that more than one type of volumetric measurement may be provided on the at least one syringe 606 without departing from the present disclosure. In use, at least one syringe 606 may be filled to the recommended dosage using the color-coded or colored lines provided on the syringe. In some embodiments of the present disclosure, tapered bottle adapter 607 may be used with at least one syringe 606 to facilitate delivery of the medication.

It should be appreciated that measurement containers in different forms and shapes may be provided that may include measurement indicators. It should also be appreciated that any type or form of measurement container may provide a shape that may prevent contents from remaining in the measurement container. It also may be appreciated that a measurement kit may include six measurements spoons, a dosing spoon, a syringe, measurement instructions, and a magnifying lens in an embodiment of the present disclosure.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A measurement kit, comprising:
at least one dosage cup or container having an interior bottom shaped to prevent contents of the at least one dosage cup or container from remaining inside of the at least one dosage cup or container when the contents are emptied, the at least one dosage cup or container having a plurality of colored or color-coded measurement indicators provided about an exterior of the at least one dosage cup or container;
at least one magnifying glass or lens;
at least one dosing spoon having a plurality of colored or color-coded measurement indicators provided about an exterior of the at least one dosing spoon;
at least one measurement spoon having a spoon measurement indicator provided on a handle of the at least one spoon;
at least one syringe having a plurality of colored or color-coded measurement indicators provided about an exterior of the at least one syringe; and
a set of measurement instructions having one or more colored labels corresponding to the colored or color-coded measurement indicators provided on the at least one dosage cup or container, the at least one dosing spoon, the at least one measurement spoon, and the at least one syringe.

2. The measurement kit of claim 1, wherein the at least one measurement spoon is colored to correspond to a color provided on one of the one or more labels in the measurement instructions.

3. The measurement kit of claim 1, wherein the magnifying glass or lens is provided to enlarge the spoon measurement indicator, the plurality of colored or color-coded measurement indicators, and any text or symbols provided on the at least one dosage cup or container, the at least one measurement spoon, the at least one dosing spoon, and the at least one syringe.

4. The measurement kit of claim 1, wherein the measurement kit is sized to fit into existing medicine containers or boxes.

5. The measurement kit of claim 1, wherein the plurality of colored or color-coded measurement indicators use primary colors including orange, purple, green, yellow, red, and blue.

6. The measurement kit of claim 1, wherein the at least one syringe further includes a tapered bottle adapter.

7. The measurement kit of claim 1, wherein the at least one measurement spoon further includes a semicircle attachment that attaches the at least one measurement spoon to a medicine bottle.

8. A measurement kit, comprising:
at least one dosage cup or container having a plurality of colored or color-coded measurement indicators provided about an exterior of the at least one dosage cup or container;
at least one magnifying glass or lens;
at least one dosing spoon having a plurality of colored or color-coded measurement indicators provided about an exterior of the at least one dosing spoon, wherein the plurality of colored or color-coded measurement indicators correspond to the one or more colored labels provided on the set of measurement instructions; and
a set of measurement instructions having one or more colored labels corresponding to the colored or color-coded measurement indicators provided on the at least one dosage cup or container and the at least one dosing spoon.

9. The measurement kit of claim 8 further comprising:
at least one measurement spoon having a spoon measurement indicator provided on a handle of the at least one spoon, wherein the at least one measurement spoon is colored to correspond to one of the one or more colored labels provided on the set of measurement instructions.

10. The measurement kit of claim 8 further comprising:
at least one syringe having a plurality of colored or color-coded measurement indicators provided about an exterior of the at least one syringe, wherein the plurality of colored or color-coded measurement indicators correspond to the one or more colored labels provided on the set of measurement instructions.

11. The measurement kit of claim 9, wherein the at least one measurement spoon further includes a semicircle attachment that attaches the at least one measurement spoon to a medicine bottle.

12. The measurement kit of claim 8, wherein the measurement kit is sized to fit into existing medicine containers or boxes.

13. The measurement kit of claim 8, wherein the plurality of colored or color-coded measurement indicators use primary colors including orange, purple, green, yellow, red, and blue.

14. The measurement kit of claim 8, wherein the at least one dosage cup or container has an interior bottom shaped to prevent contents of the at least one dosage cup or container from remaining inside of the at least one dosage cup or container when the contents are emptied.

15. A measurement kit, comprising:
at least one dosage cup or container having a plurality of colored or color-coded measurement indicators provided about an exterior of the at least one dosage cup or container;
at least one magnifying glass or lens; and
a set of measurement instructions having one or more colored labels corresponding to the colored or color-coded measurement indicators provided on the at least one dosage cup or container,
wherein the measurement kit is sized to fit into existing medicine containers or boxes.

16. The measurement kit of claim 15 further comprising:
at least one dosing spoon having a plurality of colored or color-coded measurement indicators provided about an exterior of the at least one dosing spoon, wherein the plurality of colored or color-coded measurement indicators correspond to the one or more colored labels provided on the set of measurement instructions.

17. The measurement kit of claim 15 further comprising:
at least one measurement spoon having a spoon measurement indicator provided on a handle of the at least one spoon, wherein the at least one measurement spoon is colored to correspond to one of the one or more colored labels provided on the set of measurement instructions.

18. The measurement kit of claim 15 further comprising:
at least one syringe having a plurality of colored or color-coded measurement indicators provided about an exterior of the at least one syringe, wherein the plurality of colored or color-coded measurement indicators correspond to the one or more colored labels provided on the set of measurement instructions.

19. The measurement kit of claim 15, wherein the at least one dosage cup or container has an interior bottom shaped to prevent contents of the at least one dosage cup or container from remaining inside of the at least one dosage cup or container when the contents are emptied.

20. The measurement kit of claim 17, wherein the at least one measurement spoon further includes a semicircle attachment that attaches the at least one measurement spoon to a medicine bottle.
